(19) United States
(12) Patent Application Publication
(10) Pub. No.: US 2020/0298583 A1
(43) Pub. Date: Sep. 24, 2020

(54) PRINTING INK CONTAINER FOR A DEVICE FOR PRINTING CONTAINERS

(71) Applicant: KHS GmbH, Dortmund (DE)

(72) Inventor: Sascha Koers, Bergkamen (DE)

(21) Appl. No.: 16/088,667

(22) PCT Filed: Mar. 22, 2017
(86) PCT No.: PCT/EP2017/056888

§ 371 Date: Sep. 26, 2018

(30) Foreign Application Priority Data
Apr. 4, 2016 (DE) 10 2016 106 111.5

(51) Int. Cl. B41J 2/175

(52) U.S. Cl. CPC B41J 2/17566

(57) ABSTRACT

An ink container comprises a tank and a measurement unit. The tank accommodates printing ink. The measurement unit has a sensor arrangement, a memory, an energy store, and a first interface. The sensor arrangement captures measurement values that are relevant to the printing ink. The memory stores at least some of these measurement values. The interface provides a way to communicate the measurement values to a printing machine.

### RELATED APPLICATIONS

This is the national stage entry for international application PCT/EP2017/056888, filed on Mar. 22, 2017, which claims the benefit of the Apr. 4, 2016 filing date of German application DE 10-2016106111.5, the contents of which are herein incorporated by reference.

### FIELD OF INVENTION

The invention relates to a ink container, to a device for printing containers and to a method for monitoring the printing ink quality during the printing of containers.

### BACKGROUND

Labels have long been used to place information on a container. Such information is useful to identity the type of beverage in a container, its manufacturer, and the amount of beverage in it. Such information is also useful for marketing purposes.

A disadvantage of labels is that they can come off the container. This disadvantage is alleviated by printing directly on the container, thus dispensing with the need for a label.

In order to achieve a sharp image with brilliant color that will stick to the container, it is important that the ink be formulated correctly. To avoid sediment, it is important that the ink be agitated periodically. It is also important to avoid exposing to an environment that may promote degradation as well as to replace the ink promptly once it has degraded.

### SUMMARY

The invention features an ink container that enables ink quality to be monitored so as to guarantee an adequate level of quality.

According to a first aspect, the invention relates to an ink container. The ink container comprises a tank for accommodating printing ink as well as a measurement unit. The measurement unit comprises a sensor arrangement, a memory unit, an energy store and an interface unit. The sensor arrangement is configured for capturing measurement values relevant to the printing ink.

These measurement values are stored, at least partly, as data records in the memory unit. The sensor arrangement is coupled to the memory unit in such a way that the measurement values supplied by the sensor arrangement are stored in the memory unit as data records.

In some embodiments, the measurement values and data records are stored chronologically and with a time stamp and can be read out at a later time and can processed.

The energy store supplies the measurement unit with electrical energy.

The interface unit provides a way to communicate measurement values and parameters obtained by the sensor arrangement or stored in the memory unit to be communicated to the printing machine.

An essential advantage of the ink container is that the measuring unit makes it possible to monitor the quality of the ink from the time that the manufacturer fills the container with ink to the time that the consumer uses that ink. It does so using data logging and thus ensures high-quality container filling.

Embodiments include those comprising one or more of a temperature sensor, a motion sensor, a gas sensor, and an ultraviolet sensor. These sensors enable capture values of different values that are all germane to determining or inferring the ink quality.

As used herein, “ink” includes such fluids as printing ink, pigment-free priming, coating or varnishing fluids, and cleaning fluids.

Some embodiments include first and second temperature sensors: one to measure the ink temperature and another to independently measure the ambient temperature in the tank's surroundings. As a result it is for example possible to determine whether the ambient temperature and/or the temperature of the printing ink has fallen below a particular temperature threshold or outside a range of permissible temperatures. This is useful knowledge for knowing if the ink's quality may have been impaired as a result of exposure to improper temperatures.

Another embodiment features an ink-level sensor that measures the ink level in the tank. Embodiments include capacitive ink-level sensors and hydrostatic ink-level sensors. The ink-level sensor makes it possible to measure the ink level not only when the ink container is actually being used in a printing machine but also when it is stored. The ink-level sensor can acquire a measurement continuously, intermittently, or in response to certain events. The ability to obtain such information before the ink container is actually put to use in a printing machine makes it possible to determine whether it should be put to use at all.

Some embodiments also feature a controller that is configured to cause measurement values from the sensor arrangement to be stored at different times in the memory unit. The controller is configured to carry this out continuously, intermittently, or in response to particular events.

According to one embodiment, a controller stores the measurement values supplied by the sensor arrangement in the memory unit at different times. Embodiments include those in which the controller does so continuously, intermittently, or in response to particular events.

Some embodiments feature an energy management unit that is integrated into a controller unit or that is a separate component that is not integrated into the controller unit. The energy management unit makes it possible to carry out time-controlled or event-controlled capture of measurement values with reduced energy consumption.

In some embodiments, the interface unit comprises a contact panel for the electrical connection of the measurement unit to a readout apparatus provided on the printing device. This readout apparatus can include a contact panel that corresponds to the contact panel on the ink container. The contact panel makes it possible to exchange measurement values between the memory unit and the printing machine.

In some embodiments, read out is carried out by a control device that is separate from the printing machine, such as a handheld interrogator. In these embodiments, the interface unit is a wireless interface unit that includes an antenna. The wireless interface unit carries out wireless coupling between the measuring unit and the handheld interrogator. A variety of wireless protocols can be used, including WLAN, BLUETOOTH(R) AND infrared-based protocols. Alternatively, a readout apparatus is part of a control device, such as a handset, that can be used to promote quality control of the ink.

Other embodiments feature a combination of wireless and wired data coupling.

In some embodiments, the energy store includes a non-rechargeable battery, whereas in others it is a rechargeable battery. In either case, it becomes possible to operate the measurement unit without having to have it tethered to an external energy supply. As a result, it becomes possible to carry out measurement even when the ink container is not in use.

In operation, when the ink container is docked into the printing machine, it receives energy from an external supply through the printing machine. When undocked, it continues to operate because of its energy store.

According to one embodiment, the sensor arrangement comprises a sensor for determining the position of the ink container, for example a GPS sensor. By way of this GPS sensor it is possible to trace and/or record the transport path and/or the storage sites of the ink container.

In another aspect, the invention features a printing machine for printing on containers. The printing machine includes a printing station having a print head and a receptacle for an ink container that includes a measurement unit.

Among the embodiments are those in which the printing machine has a controller and an interface for exchanging information with the measurement unit. Examples of a controller include a processor and a microcontroller. The controller reads out measurement values or parameters that have been stored in a memory unit of the measurement unit and evaluates those measurement values or parameters. The controller also permits the ink in the ink container to be used in particular ways or not used at all based on the results of such an evaluation. This makes it less likely ink that has been degraded, for example as a result of age, exposure to improper temperature or exposure to ultraviolet light. It also makes it possible to avoid accidentally using ink that has the wrong color.

In still other embodiments, before using ink from the ink container for the first time, the controller reads measurement values and parameters stored in memory and to permit the ink container to be used only if those parameters indicate that the ink is likely to meet quality criteria.

In other embodiments, the controller evaluates one or more of measured temperature, measurements indicative of motion of the ink container, such as shaking, measurements indicative of exposure to ultraviolet radiation, and measurements of gas concentrations.

In yet other embodiments, the controller compares a use-by date stored in the memory unit with the current date and disables use of the ink container accordingly.

In another embodiment, the controller reads, from the memory unit, a series of ink-level measurements recorded at different times and to control use of the printing ink based on these measurements. This makes it possible to check whether the ink container has been improperly filled, for example with printing ink that may fail to meet the required quality criteria.

According to one embodiment, the controller compares measured consumption values of ink of a certain color with an ink-level profile that indicates how fast ink is expected to be consumed. If the controller discovers an inconsistency, it interrupts or disables printing. This provides a way to detect if, for example, a different reservoir is supplying ink or if there are leaks in the ink supply.

In another aspect, the invention features a method for monitoring ink quality of ink that is to be used by a printing machine that prints on containers. The printing machine has at least one printing station having a printing head and at least one receptacle for an ink container that comprises a measurement unit and that serves as an ink reservoir for supplying the printing head with printing ink. The method comprises: using a measurement unit to capture measurement values that influence the ink's quality, including doing so before the ink is actually being used in the printing machine; storing the captured measurement values in a memory unit of the measurement unit; having the printing machine read out the stored measurement values; having a controller of the printing machine evaluate the measurements that have been read from the memory unit; and enabling the ink stored in the ink container to be used in the printing machine if the analysis indicates that the measurement values that have been read out either values correspond to nominal measurement values and/or lie within a given range of nominal measurement values.

Additional practices further include the steps of producing the ink filling the ink container with that ink, transporting the ink container to the printing machine, docking the ink container in a receptacle on the printing machine so as to form connections for fluid flow, for energy transfer, and for data transfer, and then printing on containers with the ink.

As used herein, the term “container” refers to all kinds of packaging, including bottles, cans, bags, and pouches.

As used herein, “printing ink” includes ink that is suitable for use in printing on containers, and in particular, on plastic containers, using an inkjet printer.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

### BRIEF DESCRIPTION OF THE DRAWINGS

The invention is explained in detail below through the use of embodiment examples with reference to the figures, in which:

FIG. 1 shows a printing device having a single transport element comprising a plurality of printing stations;

FIG. 2 shows a printing device built up out of a plurality of modules;

FIG. 3 shows a sectional side view of an ink container comprising a measurement unit; and

FIG. 4 shows an ink container docked into a receptacle of a printing device and a connection of the ink container to the printing device.

### DETAILED DESCRIPTION

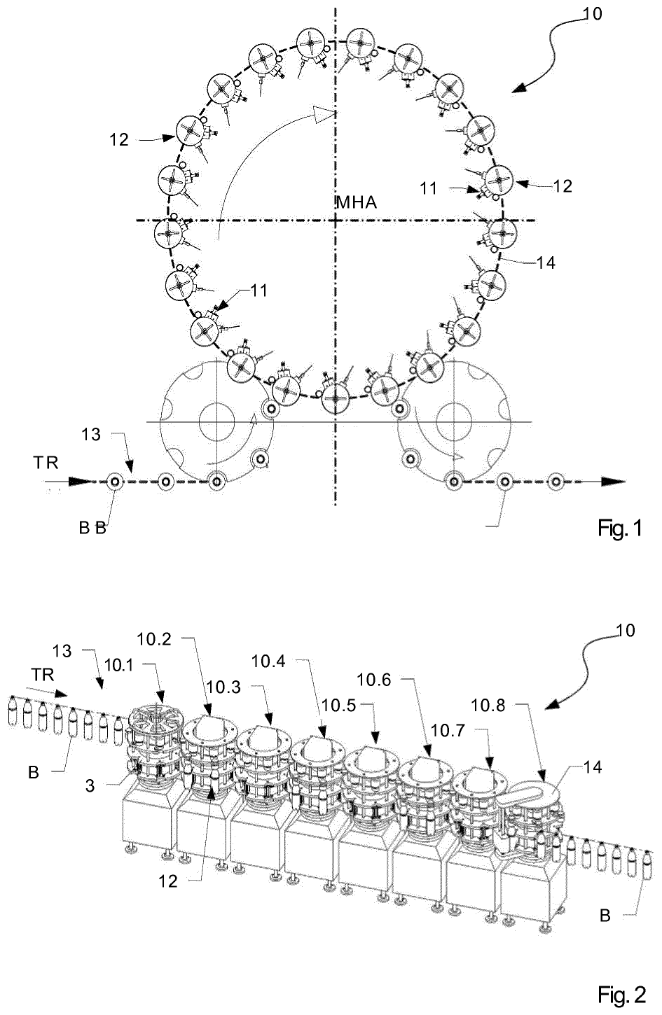

FIG. 1 shows a printing machine 10 that uses inkjet printers to print a multi-colored image on an outer surface of a container B. A transporter 13 feeds a single track of upright containers B in a transport direction TR to the printing machine 10. A transport star receives these containers B at an infeed and transfers them to a rotor 14 that rotates about a machine axis MHA.

The rotor 14 has multiple printing stations 12 disposed around a periphery thereof at equal angular distances from each other. Each printing station 12 includes at least one print head 11. In some embodiments, there are several print heads 11, each of which prints a different color. Each printing station 12 also includes a container carrier that suspends a container B from a region near the container's mouth.

As the rotor 14 moves a container B from the infeed to a container discharge, the printing station 12 prints on the container B. In doing so, the printing station 12 rotates the container B about a vertical axis thereof.

In another embodiment, shown in FIG. 2, a conveyor transports upright containers B along a transport direction TR to the printing machine 10. The containers B then follow a meandering path through the printing machine 10. The meandering path includes multiple actuate deflections.

The printing machine 10 shown in FIG. 2 includes modules 10.1-10.n arranged one after the other along the transport direction TR. In the illustrated embodiment, there are eight such modules 10.1-10.8. Each module 10.1-10.n has a base unit and a functional unit. All the modules 10.1-10.n have the same kind of base unit. They differ only in having different kinds of functional units. The components necessary to carry out the particular function of a module 10.1-10.n are in the function unit.

In a typical printing machine 10, the function modules 10.1-10.8 include pre-treatment modules, printing modules, and post-treatment modules, such as those for drying and inspecting container B. Among the printing modules are those for carrying out multiple-pass printing in which different printing modules apply different primary colors. In some embodiments, the second through fifth modules 10.2-10.5 print yellow, magenta, cyan, and black, though not necessarily in that order.

Each base unit has a rotor 14 that rotates about a vertical machine-axis of the module 10.1-10.8. A typical rotor 14 is a transport star or process star with receptacles disposed around a periphery thereof and distributed at equal angular distances. Each receptacle securely accommodates a container B.

Rotors 14 of adjacent modules 10.n-10.(n+1) rotate synchronously in opposite directions to permit one module 10.n to hand a container B off to the adjacent module 10.(n+1). As a rotor 14 transports a container B around a module, 10.n, the container B rotates about its own container axis as well so that the printing head 11 can access the container's entire surface.

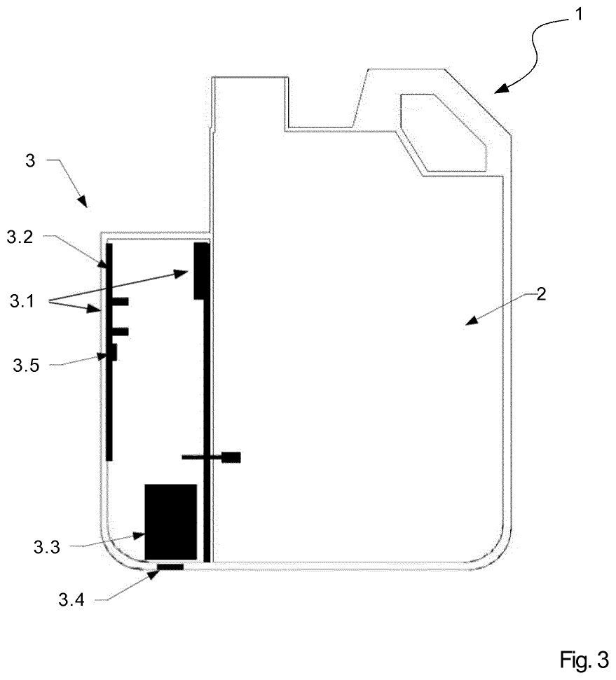

FIG. 3 shows a side view of an ink container 1 for supplying printing ink to the printing stations 12, and in particular, to the print heads 11 at the printing stations 12.

The ink container 1 includes a tank 2 and a measurement unit 3.

The tank 2 defines an ink reservoir for receiving ink. Supply lines connect an outlet under the tank 2 to the printing heads 11. As a result, the tank 2 is on a non-rotating machine part. Optional conveying units and intermediate reservoirs define part of a fluid connection between the tank 2 and the printing heads 11.

The measurement unit 3 attaches firmly to the tank 2. In some embodiments, the measurement unit 3 is integrated into a region of the ink container's housing. In alternative embodiment, the measurement unit 3 is in a separate housing that connects to the tank 2. Suitable ways to establish such a connection include cold welding and adhesive bonding.

The measurement unit 3 can be placed at various locations. For instance, in FIG. 3, the measurement unit 3 is on the tank's sidewall. In other embodiments, the measurement unit 3 has different parts that are at different locations on the ink container 1.

The measurement unit 3 comprises a sensor arrangement 3.1, a memory unit 3.2, an energy store 3.3, and an interface unit 3.4.

The sensor arrangement 3.1 comprises sensors for capturing measurement values of different measured variables. Examples of such measured variables include temperature, accelerations resulting from shaking, vibration, or shock movements, fill level, levels of ultraviolet radiation, and concentrations of one or more gases in the tank 2.

In some embodiments, the sensor arrangement 3.1 also includes a GPS sensor that determines the position of the ink container 1. This is useful to determine and track the local position of the ink container 1, for example, from the printing ink manufacturer to the use of the ink container 1 in a printing machine 10.

In those embodiments of the sensor arrangement 3.1 that measure temperature, there can be first and second temperature sensors. The first temperature sensor is at least partly within the tank's interior or projects into the tank's interior. This first temperature sensor measures the ink's temperature. The second temperature sensor is outside the tank 2. This second temperature sensor measures the ambient temperature in the area surrounding the tank 2. Since ambient temperature can be subject to significant fluctuation, having both measurements provides a way to draw useful conclusions about the ink's quality and/or its condition.

Those embodiments of the sensor arrangement 3.1 that measure motion include motion sensors, such as shock sensors or accelerometers. Some of these embodiments feature three motion sensors, one for each of the orthogonal axes along which translation can take place. Some embodiments feature motion sensors that can detect movement in a plane defined by two orthogonal axes.

In some embodiments, the sensor arrangement 3.1 also comprises an ink-level sensor to quantity how much ink is in the tank 2 can be determined. Examples of ink-level sensors include capacitive or hydrostatic ink-level sensors. An ink-level sensor can be provided entirely outside the tank 2, at least partly projecting into the tank 2, or integrated into the tank 2.

Some embodiments of the sensor arrangement 3.1 include an ultraviolet sensor that measures ultraviolet radiation. This is useful since excessive ultraviolet exposure can impair the quality of the printing ink.

Some embodiments of the sensor arrangement 3.1 include a gas sensor configured to measure concentrations of certain gases. In one embodiment, the gas sensor senses nitrogen in the tank 2.

A gas sensor provides a way to detect tampering. For example, it is possible to initially fill the tank 2 at least partly with a gas that the gas sensor can detect and that is either not in the environment or in the environment in a different concentration. In that case, if the tank 2 is opened for unauthorized refilling, the gas sensor would detect a change in the gas content.

The memory unit 3.2 stores measurement values captured by the sensor arrangement 3.1. Additionally, the memory unit 3.2 stores other measurement values and parameters that are relied upon by a printing-machine controller 21 for controlling operation of the printing machine 10. These are typically stored before the ink container 1 is actually connected to the printing machine 10.

Alternatively, or in addition, it is possible for the measurement unit 3 to record measurements and transmit them to the printing-machine controller 21 even while containers B are being printed upon. This is particularly useful when monitoring the ink level in the tank 2.

The memory unit 3.2 makes it possible to store measurement values captured by the sensor arrangement 3.1 continuously, at periodic time intervals, or in in response to occurrence of certain conditions, such as a sudden movement or sudden temperature change. It is then possible to later inspect these measurement values and to draw conclusions concerning the ink's condition and/or the ink's quality.

In some embodiments, the memory unit 3.2 stores certain parameters that characterize the ink. Examples of such parameters include the ink container's unique identifier, such as a batch identifier, the ink's use-by date, or any identifier that characterizes the ink's color or any of its properties.

In some embodiments, the measurement unit 3 comprises a printed circuit board that carries the memory unit 3.2 and a controller unit 3.5 that contains the printing-machine controller 21. A suitable printing-machine controller 21 is a micro-controller. Among these are embodiments in which the printed circuit board comprises one or more of the sensors of the sensor arrangement 3.1.

In such embodiments, it is particularly useful for the controller unit 3.5 to control the storing or logging of the measured data.

Examples of an energy store 3.3 include a non-rechargeable or rechargeable battery. The energy store 3.3 provides energy to operate measurement unit 3. This permits the measurement unit 3 to operate for extended periods, for example, on the order of months, without having to be connected to an external energy source. As a result, it becomes possible to capture considerable amounts of data between the manufacturing of the ink container 1 or the date on which the ink manufacturer refills the ink container 1 and the use of the ink in a printing machine 10.

The interface unit 3.4 provides a way to transfer data between the printing machine 10 and the measurement unit 3. Examples of an interface unit 3.4 include a contact panel on the outside of the ink container 1 for connection to a corresponding contact panel on the printing machine 10. The interface unit 3.4 permits transfer of both data and electrical energy between the printing machine 10 and the measurement unit 3. This makes it possible to supply the measurement unit 3 during use and to recharge its energy store 3.3.

An alternative implementation features a wireless interface unit 3.4. Also among the alternative implementations is one in which the interface unit 3.4 facilitates wired and wireless data communication. Such an interface unit 3.4 includes a contact panel for wired communication and an antenna unit for near-field communication.

A wireless interface unit 3.4 makes it possible to inspect the ink container 1 from outside the printing machine 10 using a manually operated device that interrogates the measurement unit 3.

In other embodiments, the measurement unit 3 includes an energy management unit. The energy management unit is either separate from the controller unit 3.5 or incorporated into the controller unit 3.5. The energy management unit makes it possible to activate the measurement unit 3 from a standby state in response to an event not certain to occur. Examples of such events include a temperature sensor reporting a temperature that has moved outside a permissible range or a motion sensor that has detected an abrupt acceleration. Following such a triggering event, the measurement unit 3 records measurement values. It does so either for a predefined period or in response to another event not certain to occur, such as a temperature sensor reporting a temperature that has moved back to a permissible range. This reduces energy consumption by the measurement unit 3 and thus extends the life of the energy store 3.3.

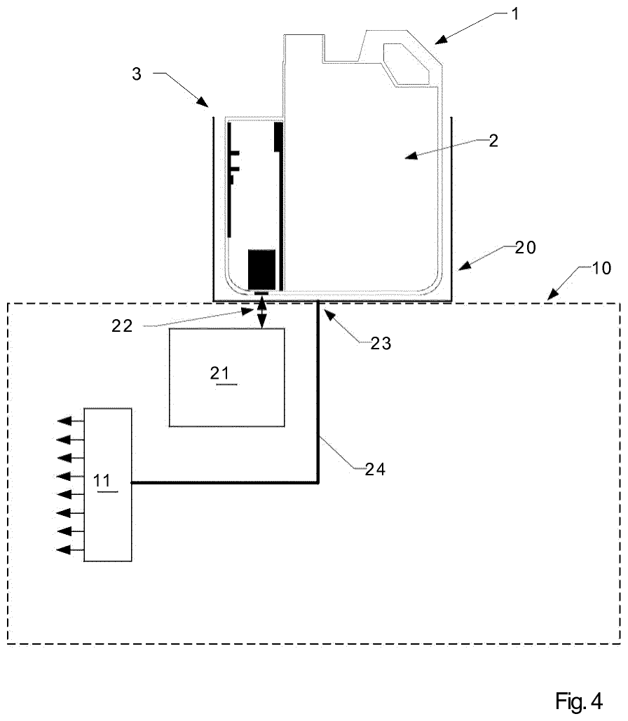

As shown in FIG. 4, the printing machine 10 includes a receptacle 20 into which it is possible to dock the ink container 1. As a result of its shape, docking the ink container 1 into the receptacle 20 causes the receptacle 20 to fix the ink container 1 to the printing machine 10. In some embodiments, the receptacle 20 is on top of the rotor 14 or wherever the printing stations 12 that print on the containers B with the relevant color are located.

The receptacle 20 has an interface 22 that connects to the interface unit 3.4. In some embodiments, the interface 22 is a contact panel that interacts with a similar contact panel provided on the ink container 1 so as to permit data transmission from the measurement unit 3 of the ink container 1 to the printing machine 10. In other embodiments, the receptacle's interface 22 wirelessly links to the interface unit 3.4 using a suitable near-field communication interface, such as Bluetooth, or using a line-of-sight communication interface, such as an interface that relies on transmitting and receiving infrared radiation.

The interface 22 links the measurement unit 3 to the printing-machine controller 21 so that data stored in the memory unit 3.2 can be transferred to the printing-machine controller 21. The printing-machine controller 21 then evaluates this data and controls the printing machine 10 based on the result of such evaluation.

The receptacle 20 also comprises an inlet 23 through which ink flows from the tank 2 into the printing machine 10. The inlet 23 matches a corresponding outlet of the ink container 1. As a result, placing the ink container 1 in the receptacle 20 creates a fluid-tight connection between the outlet and the inlet 23.

The inlet 23 connects to the printing head 11 through one or more supply lines 24 so as to supply the printing head 11 with ink. As indicated in FIG. 4, in one embodiment, the inlet 23 connects to the printing head 11 with no intermediate storage for printing ink so that the only printing ink reservoir upstream of the printing head 11 is the tank 2 itself. In such cases, it may be necessary to provide suitable conveying units. In an alternative embodiment, one or more intermediate tanks and treatment modules lie between the printing head 11 and the tank 2. These are particularly useful when the ink is to be treated in some way before being used, for example by heating it or degassing it.

The measurement unit 3 logs or monitors the initial filling of the ink container 1 at the printing ink manufacturer. It is thus possible to authenticate the ink by having certain parameters be written into a secure area of the memory unit 3.2. Examples of such information include information about the ink's color, its batch number, its production date, the tank's filling date, the date by which the ink should be used or replaced, and any other information from which quality of the ink can be inferred or derived. Upon docking a new ink container 1 into a printing machine 10, and preferably before first using the ink, it is useful to read out these parameters to confirm that the ink is authentic and has not been tampered with.

The measurement unit 3 also makes it possible to monitor the quality of the ink container 1 and the ink stored therein from the time it is filled to the time the ink is used. For example, the measurement unit 3 is able to record the temperature of the ink or the temperature in the vicinity of the ink container 1. The measurement unit 3 is also able to detect accelerations that may be strong enough to damage the ink container 1. Information about acceleration is also useful to determine if the ink has been shaken well enough, for example for at least a recommended period and amplitude, to avoid sediment and to ensure that it is thoroughly mixed. Information about acceleration is also useful to determine if the ink container 1 was properly inserted.

The measurement sensor 3 can also monitor ink level to identify any conspicuous fluctuations that might suggest an emptying or re-filling of the ink. This provides another way to detect unauthorized filling or re-filling in addition to the use of the gas sensor as already described.

The measurement sensor 3 can also use an ultraviolet sensor to determine if the ink has been exposed to ultraviolet radiation to an extent that may degrade its quality.

The position sensor or GPS sensor of the measurement sensor 3 is useful for tracking the locations in which the ink container 1 has been stored and where it has travelled over time.

Once the ink container 1 has been docked into the printing machine 10, it is possible for the printing-machine controller 21 to interrogate the memory unit 3.4 to retrieve any or all of the foregoing data and to analyze it. Based on such analysis, the printing-machine controller 21 controls the printing machine 10 so as to optimize the way the ink is used, or if the ink has been degraded to the point of being unusable, the printing-machine controller 21 disables printing using that ink.

In some practices, the printing-machine controller 21 monitors an ongoing printing process. For example, based on the number of containers B printed upon and on the fill level, it is possible to determine how much ink is being used per container B on a per color basis. This, in turn, provides a way of inferring whether the ink container 1 is actually supplying the ink or whether it may be coming from an unauthorized source. It also provides a way of inferring whether more ink is being taken from the ink container 1 than is actually being used by the printing heads 11, i.e., that ink is being purloined or that there is a leak in the supply. Additionally, this also makes it possible to use the ink level to appropriately control the printing machine 10.

The invention has been described herein by reference to a finite number of embodiments. However, this is not to say that only these embodiments are within the invention's scope. In fact, the scope of the invention is determined based on the attached claims.

According, what is new and for which Letters Patent is sought is:

1-17. (canceled)

18. An apparatus comprising an ink container, wherein said ink container comprises a tank and a measurement unit, wherein said measurement unit comprises a sensor arrangement, a memory, an energy store, and a first interface, wherein said tank accommodates printing ink, wherein said sensor arrangement is configured to capture measurement values that are relevant to said printing ink, wherein said memory stores at least some of said measurement values, and wherein said interface provides a way to communicate said measurement values to a printing machine.

19. The apparatus of claim 18, wherein said sensor arrangement comprises a temperature sensor, a motion sensor, a shock sensor, an ultraviolet sensor, and a gas sensor.

20. The apparatus of claim 19, wherein said temperature sensor is a first temperature sensor that is configured to capture temperature in a region surrounding said measurement unit and wherein said measurement unit comprises a second temperature sensor that is configured to capture temperature of said printing ink in said tank.

21. The apparatus of claim 18, wherein said sensor arrangement comprises an ink-level sensor configured to measure a level of said printing ink in said tank.

22. The apparatus of claim 18, wherein said ink tank further comprises a tank-controller unit configured to cause measurement values supplied by said sensor arrangement to be stored at different times in said memory.

23. The apparatus of claim 18, wherein said interface unit comprises a contact panel configured to permit electrical connection of said measurement unit to a readout apparatus provided on said printing machine.

24. The apparatus of claim 18, wherein said interface unit comprises a wireless connection configured to permit wireless connection of said measurement unit to a readout apparatus provided on said printing machine.

25. The apparatus of claim 18, wherein said energy store comprises a battery.

26. The apparatus of claim 18, wherein said sensor arrangement comprises a location sensor configured for determining a position of said ink container.

27. The apparatus of claim 18, further comprising a printing station, a printing-machine controller, a second interface, and a receptacle, wherein said printing station comprises a printing head, wherein said receptacle is configured to dock said ink container to said printing machine, and wherein said printing station, said second interface, and said printing-machine control unit are parts of said printing machine, wherein said second interface permits exchange of information between said measurement unit and said printing-machine control unit, and wherein said printing-machine control unit is configured to disable use of said ink in said container as a result evaluation of data obtained by said measurement unit.

28. The apparatus of claim 27, wherein said printing-machine controller is configured to, prior to first use of said ink in said printing machine, acquire data from said measurement system, to evaluate said data, and to disable use of said ink based on a result of said evaluation.

29. The apparatus of claim 27, wherein said printing-machine controller evaluates temperatures, data indicative of movement of said ink tank, data indicative of tank vibration, and a use-by date stored in said memory.

30. The apparatus of claim 27, wherein said printing-machine controller is configured to read, from said memory, ink-levels that have been measured at different times and to prevent use of ink in said ink container based at least in part on said ink levels.

31. The apparatus of claim 27, wherein said printing-machine controller is configured to compare a measured ink-level profile of ink in said ink container with an expected ink-level profile for said ink container and to interrupt printing if said consumption rate is inconsistent with said ink-level profile.

32. A method comprising monitoring printing-ink quality during printing on containers using a printing machine having a printing station that has a printing head and a receptacle for receiving an ink container that comprises a measurement unit and that supplies said printing head with ink, said method comprising, using said measuring unit, capturing measurement values that influence quality of said ink, wherein at least some of said measurement values are captured prior to first using ink in said ink container for printing, storing said captured measurement values in a memory of said ink container, at said printing machine, reading said measurement values, causing a printing-machine control unit to evaluate said measurement values, and enabling use of said ink in said printing machine if said evaluation reveals that said measurement values are consistent with corresponding nominal values and disabling use of said ink otherwise.

33. The method of claim 32, further comprising producing said ink and filling said ink container with said ink, transporting said ink container to said printing machine, docking said ink container into said receptacle, and controlling release and use of said ink during printing on said containers.

34. The method of claim 32, further comprising sealing and storing said ink container.
